(19) United States
(12) Patent Application Publication
(10) Pub. No.: US 2025/0347609 A1
(43) Pub. Date: Nov. 13, 2025

(54) PARTICLE COUNTING SYSTEM

(71) Applicant: Beckman Coulter, Inc., Brea, CA (US)

(72) Inventor: Marco Zuleta, Brea, CA (US)

(21) Appl. No.: 19/199,628

(22) Filed: May 6, 2025

Related U.S. Application Data
(60) Provisional application No. 63/644,259, filed on May 8, 2024.

(51) Int. Cl. G01N 15/13; G01N 15/01; G01N 15/10; G01N 15/12

(52) U.S. Cl. CPC G01N 15/13; G01N 15/01; G01N 15/134; G01N 2015/012; G01N 2015/1024; G01N 2015/1029; G01N 2015/138

(57) ABSTRACT

A biological particle counting system can include: an impedance particle counter comprising at least one sample aperture; a pump configured to pull particles through the at least one sample aperture of the impedance particle counter for counting, the pump producing a vacuum pressure; and a stepper motor configured to adjust a speed of the pump to substantially maintain the vacuum pressure.

### CROSS REFERENCE TO RELATED APPLICATIONS

The present application claims priority to and the benefit of U.S. Prov. No. 63/644,259, filed on May 8, 2024, the entirety of which is incorporated by reference herein.

### BACKGROUND

Generally, this application relates to particle counting systems, such as biological particle counting systems, hematology analyzers, impedance detectors, or Coulter Counters.

### SUMMARY

The following description of embodiments are illustrative.

According to embodiments, a biological particle counting system includes: an impedance particle counter comprising at least one sample aperture; a pump (e.g., a peristaltic pump, a syringe pump, or helical pump) configured to pull particles through the at least one sample aperture of the impedance particle counter for counting, the pump producing a vacuum pressure; and a stepper motor configured to adjust a speed of the pump to substantially maintain the vacuum pressure. The impedance particle counter is configured to determine a count and size of the particles. A sensor is configured to monitor the vacuum pressure. A processor may be in communication with the sensor and the stepper motor, wherein the processor is configured to adjust the stepper motor to adjust the speed of the pump according to a signal from the sensor. The processor may be further configured to adjust the stepper motor according to proportional-derivative negative feedback according to the signal from the sensor. The processor may be further configured to detect a condition of the at least one sample aperture. The processor may be further configured to push a fluid through the at least one sample aperture according to the condition of the at least one sample aperture. The processor may be further configured to detect a change in a condition of the pump. The pump may be further configured to produce a sweep flow configured to move the particles away from the at least one sample aperture after counting. A processor may be configured to detect a condition of the sweep flow. The processor may be further configured to control the stepper motor to adjust the speed of the pump according to the condition of the sweep flow. The pump may be further configured to push a fluid through the at least one sample aperture. The system may further include a waste flow path, wherein the pump is in fluid communication with the waste flow path. The biological particle counting system may not include a vacuum regulator.

According to embodiments, and impedance particle counter of a impedance particle analyzer includes: at least one sample aperture; a pump (e.g., peristaltic pump, syringe pump, or helical pump) configured to pull particles through the at least one sample aperture for counting, the pump producing a vacuum pressure; and a stepper motor configured to adjust a pump speed to maintain the vacuum pressure. The impedance particle counter may be configured to determine a count and size of the particles. A sensor is configured to monitor the vacuum pressure. A processor may be in communication with the sensor and the stepper motor, wherein the processor is configured to adjust the stepper motor to adjust the pump speed according to a signal from the sensor. The processor may be further configured to adjust the stepper motor according to proportional-derivative negative feedback according to the signal from the sensor. The processor may be further configured to detect a condition of the at least one sample aperture. The processor may be further configured to push a fluid through the at least one sample aperture according to the condition of the at least one sample aperture. The processor may be further configured to detect a change in a condition of the pump. The pump may be further configured to produce a sweep flow configured to move the particles away from the at least one sample aperture. A processor may be configured to detect a condition of the sweep flow. The processor may be further configured to control the stepper motor to adjust the pump speed according to the condition of the sweep flow. The pump may be further configured to push a fluid through the at least one sample aperture. The pump may be in fluid communication with the waste flow path. The impedance particle counter may not include a vacuum regulator.

According to embodiments, a method of counting particles in a biological particle analyzer includes: utilizing a pump to pull particles through a sample aperture of an impedance particle counter for counting, the pump producing a vacuum pressure; and utilizing a stepper motor configured to adjust a pump speed to maintain the vacuum pressure.

According to embodiments, a biological particle counting system includes: an impedance particle counter comprising at least one sample aperture and a drain; and a pump connected to the drain via a tube, wherein the pump is configured to pull particles through the at least one sample aperture of the impedance particle counter for counting, the pump producing a vacuum pressure.

According to embodiments, a biological particle counting system includes: an impedance particle counter comprising a chamber, at least one sample aperture to the chamber, at least one corresponding valve for each of the at least one sample apertures; and a pump in fluid communication with the chamber, wherein the system is configured to reverse the operation of the pump and open the at least one valve corresponding the at least one aperture to attempt to force fluid from the chamber through the at least one sample aperture towards the corresponding at least one valve. The system may be configured to alternate the operation of the pump from reverse to forward to attempt to force fluid through the at least one aperture towards the corresponding at least one valve.

According to embodiments, a biological particle counting system includes an impedance particle counter comprising a chamber, at least one sample aperture to the chamber, at least one corresponding valve for each of the at least one sample apertures, wherein the system is configured to cycle the at least one corresponding valve from open to closed to create a pressure wave to unblock the corresponding at least one sample aperture.

According to embodiments, a biological particle counting system includes: an impedance particle counter comprising at least one sample aperture, a chamber, and a drain; a pump configured to pull particles through the at least one sample aperture of the impedance particle counter for counting, the pump producing a vacuum pressure to pull the particles through the drain; a vacuum sensor configured to measure a vacuum level in the chamber; and a feedback system configured to adjust the speed of the pump according to a sensed vacuum level from the vacuum sensor, wherein the system is configured to detect an error condition if the feedback system calls for the speed of the pump to exceed a predetermined range.

According to embodiments, a biological particle counting system includes: an impedance particle counter comprising at least one sample aperture, a chamber, and a drain; a pump configured to pull particles through the at least one sample aperture of the impedance particle counter for counting, the pump producing a vacuum pressure to pull the particles through the drain; and a vacuum sensor configured to measure a vacuum level in the chamber; and, wherein the system is configured to detect an error condition if the vacuum pressure is not maintained in a predetermined range during operation of the system when the pump operates at a predetermined corresponding to the predetermined range

### BRIEF DESCRIPTION OF SEVERAL VIEWS OF THE DRAWINGS

FIG. 1A illustrates a portion of a particle counting system, according to embodiments.

FIG. 1B illustrates a portion of a particle counting system, according to embodiments.

FIG. 2A illustrates a portion of a particle counting system, according to embodiments.

FIG. 2B illustrates a portion of a particle counting system, according to embodiments

FIG. 3 illustrates a flowchart for a method of operation of a particle counting system, according to embodiments.

The foregoing summary, as well as the following detailed description of certain techniques of the present application, will be better understood when read in conjunction with the appended drawings. For the purposes of illustration, certain techniques are shown in the drawings. It should be understood, however, that the claims are not limited to the arrangements and instrumentality shown in the attached drawings. Furthermore, the appearance shown in the drawings is one of many ornamental appearances that can be employed to achieve the stated functions of the system.

### DETAILED DESCRIPTION

The Coulter principle, also known as electronic sensing zone technology, is a method of characterizing the size and number of particles in a liquid sample, such as a diluted sample. According to the Coulter principle, particles can be characterized by their effect on a current-induced movement of electrolyte through one or more small sample apertures as the particle passes through the sample aperture into a chamber. Hereinafter, a sample aperture includes the case of multiple sample apertures, unless specified otherwise. Entry of a particle into the sample aperture displaces some of the charged electrolyte in the sample aperture(s), causing an increased electrical resistance across the sample aperture, resulting in an increased voltage measured across the sample aperture when current is held constant. As the particle exits the sample aperture, normal flow of electrolyte through the sample aperture resumes, resulting in a return to the starting voltage across the sample aperture before the particle entered. In this way, passage of a single particle through the sample aperture is identified by a characteristic voltage pulse across the sample aperture. The height of this voltage pulse is generally dependent on the size of the particle, since a larger particle will displace more electrolyte in the sample aperture, resulting in a larger voltage difference when the particle enters and passes through the sample aperture. The process can be duplicated for one or more additional sample apertures.

A Coulter Counter is a particle characterization device (e.g., a type of hematology analyzer) that uses the Coulter principle to determine the number and sizes of particles in a liquid sample. As may be used herein, a Coulter Counter, impedance counter, impedance particle counter, impedance detector, or impedance particle detector can generally be understood to refer to similar technology using impedance to count or assess particles. While embodiments disclosed herein may relate to a Coulter Counter, they may be applicable to more generally a particle characterization device (e.g., a hematology analyzer), as will be understood. The particle characterization device comprises two liquid-containing chambers separated by a wall, with a sample aperture in the wall that allows electrolyte and particles in the liquid of the chambers to move from one chamber to the other. A pair of electrodes is connected to a power source and disposed across the sample aperture, one electrode in each chamber. The power source provides a voltage differential across the sample aperture. Electrolytes in the liquid move from one chamber to the other in response to the applied voltage, generating an electric current. An applied force, such as a vacuum, causes the liquid to move from one chamber to the other. A detector monitors the voltage across the sample aperture, and a processor analyzes the voltage changes as liquid, electrolyte, and particles pass through the sample aperture from one chamber to the other, identifying and characterizing individual particles based on the characteristic voltage variation as the particles pass through the sample aperture.

Coulter Counters may be used to characterize the number and types of cells in a biological sample, determining, for example, the number of red blood cells, white blood cells, and platelets in a blood sample. According to such characterization, a Coulter Counter may determine a complete blood count (CBC) in a blood sample. A Coulter Counter can also be used in non-biological applications, characterizing the number and size distribution of particles dispersed in any suitable sample.

The blood count process may benefit from having a relatively stable vacuum (also referred to herein as vacuum pressure or vacuum level) to pull particles (cells and platelets or other relevant structures) through the sample aperture(s) between the chambers and into the count chamber for counting and sizing. Similarly, the process may benefit from having a relatively stable vacuum to generate the sweep flow, which is discussed below.

In addition to the sample stream, the vacuum also pulls a stream of sweep fluid (the stream is referred to herein as a “sweep flow”) through sweep fluid aperture(s) to sweep cells in the sample away from a given sample aperture after the cells traverse the sample aperture. The sweep fluid may enter the count chamber through different aperture(s) than the sample aperture(s) through which the sample flows. The sweep flow inhibits cells from exiting the sample apertures and then circulating back into the electric field and being sensed again by the electrical sensing system. Such recirculation adversely affects given particle counts, for example, platelet counts.

In certain legacy systems, a vacuum may be generated by a compressor pump in combination with a vacuum regulator and a vacuum sensor for feedback control. However, the compressor is relatively bulky, relatively loud, and produces relatively large amounts of vibration. Furthermore, the vacuum regulator is a relatively expensive component and requires additional system complexity to incorporate and implement. Furthermore, the vacuum regulator may need to be manually adjusted (e.g., via a screw) to obtain different regulated vacuum levels in the count chamber.

Furthermore, for certain legacy systems, they may not detect if the sweep flow is adequately flowing into the count chamber (e.g., there are no air bubbles in the sweep flow due to inadequate priming of the sweep flow line). Moreover, for certain legacy systems, they may utilize a count chamber that is substantially completely filled during the count period. This forces a minimum volume requirement of a given sample to prevent overflows during extended counts. Therefore, it may be beneficial to detect sweep flow, determine whether sweep flow path(s) are primed, and/or to reduce the minimum volume requirement of the sample.

According to embodiments described herein, pumps utilizing a stepper motor (such as a peristaltic pump, a syringe pump, or a helical pump) create the vacuum in the count chamber during operation of the system. Such pumps may be smaller, consume less power, and/or be quieter during operation than a compressor. According to embodiments, the vacuum regulator can be eliminated from the system design. According to embodiments, negative feedback (e.g., proportional/derivative feedback) is used to control the stepper motor in a given pump to regulate or adjust the vacuum level. According to embodiments, during operation, the count chamber is maintained in a state such that it is substantially empty of liquid. With this technique, the volume (capacity) of the count chamber can be reduced. According to embodiments, the system may detect a lack of sweep-flow priming (e.g., the presence of gas bubbles in the line). According to embodiments, the system may assess the balance of sweep-flow rates. According to embodiments, the pump can create a positive pressure in the count chamber to pressurize and clear out any blockage of the sample apertures.

According to embodiments, when a peristaltic pump is used, the system may detect peristaltic pump tubing degradation. For example, a speed threshold for the stepper motor of the pump may be predetermined in the system. If the feedback control outputs a stepper motor speed that is greater than the threshold, then this may indicate that the tubing in the peristaltic pump has degraded (e.g., there is a reduced flow through the tubing due to the tubing collapsing or the presence of accumulated material on the inner surface of the tubing). Such a technique of evaluating the controlled speed of the stepper motor to a threshold may indicate other issues with stepper motor type pumps. According to embodiments, the system may detect other aspects of the system that may be diminishing performance or creating errors or failures.

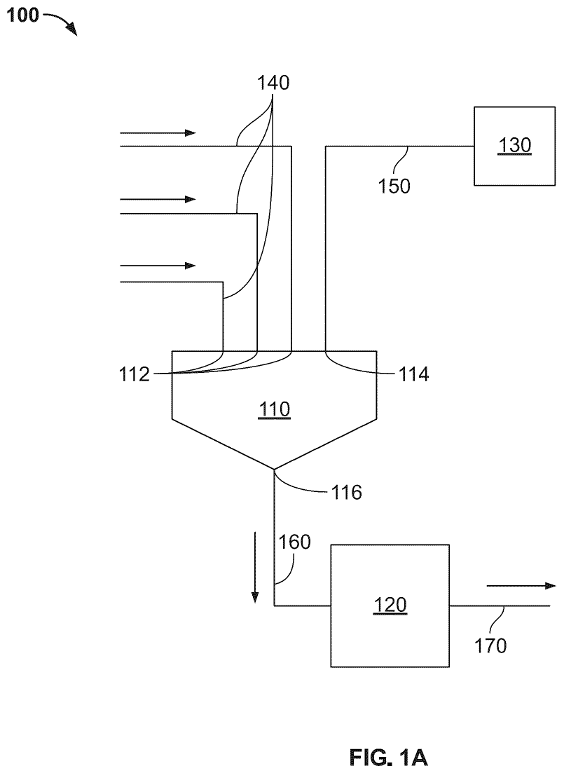

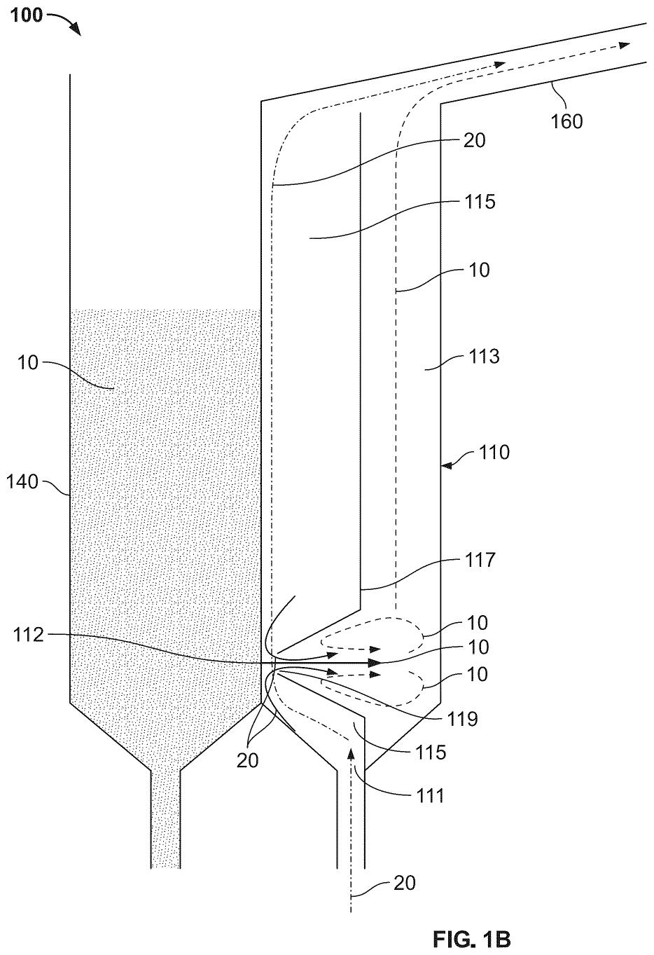

FIG. 1A illustrates a portion of a system 100, according to embodiments. The system 100 may be part of a particle characterization device or a biological particle counting system, such as a Coulter Counter or hematology analyzer. The system 100 may include a count chamber (or vacuum chamber) 110, a pump 120, a pneumatic sensor (or vacuum sensor) 130, input lines 140, a vacuum sense line 150, a drain line 160, and a waste out line 170. The count chamber 110 further includes sample apertures 112, a sense line aperture 114, and a drain aperture 116.

There may be one or more sample apertures 112 (e.g., one, two, three, etc.). Multiple apertures 112 may allow for greater throughput of the system (i.e., increased overall flow rate of the sample into the count chamber 110) and/or to provide redundancy in the case that one of the apertures 112 may become blocked or experience some other type of failure. Each aperture 112 may be sized to assess a given type of particle, such as red blood cells, white blood cells, or platelets. If only red blood cells are to be assessed by the system 100, then each aperture 112 may be sized corresponding to red blood cells—e.g. each aperture 112 may have a diameter of between approximately 40 μm to approximately 60 μm, such as approximately 50 μm, to pass the red blood cells. If other particles are to be assessed, either together with red blood cells or otherwise, then additional aperture(s) 112 may be provided corresponding to each particle type. For example, for white blood cells, aperture(s) 112 may be provided that have a diameter of between approximately 80 μm to approximately 120 μm, such as approximately 100 μm, to pass the white blood cells. Thus, a count chamber 110 may have dedicated apertures 112 for each particle type being assessed by the system 100—e.g., aperture(s) 112 sized for red blood cells, aperture(s) 112 sized for white blood cells, and/or aperture(s) 112 sized for platelets.

The count chamber 110 and associated circuitry may be part of an impedance particle counter that counts and/or determines size(s) of particles.

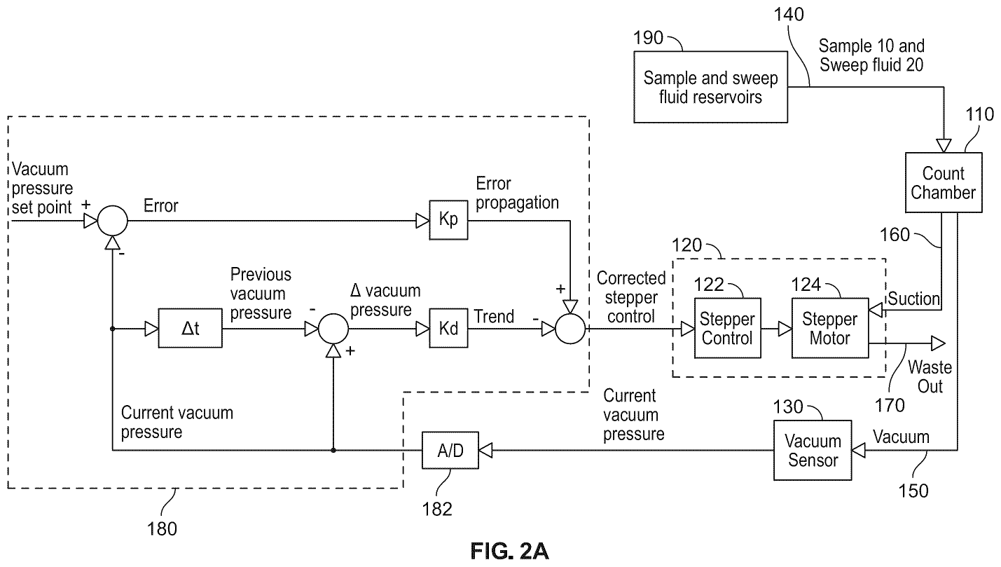

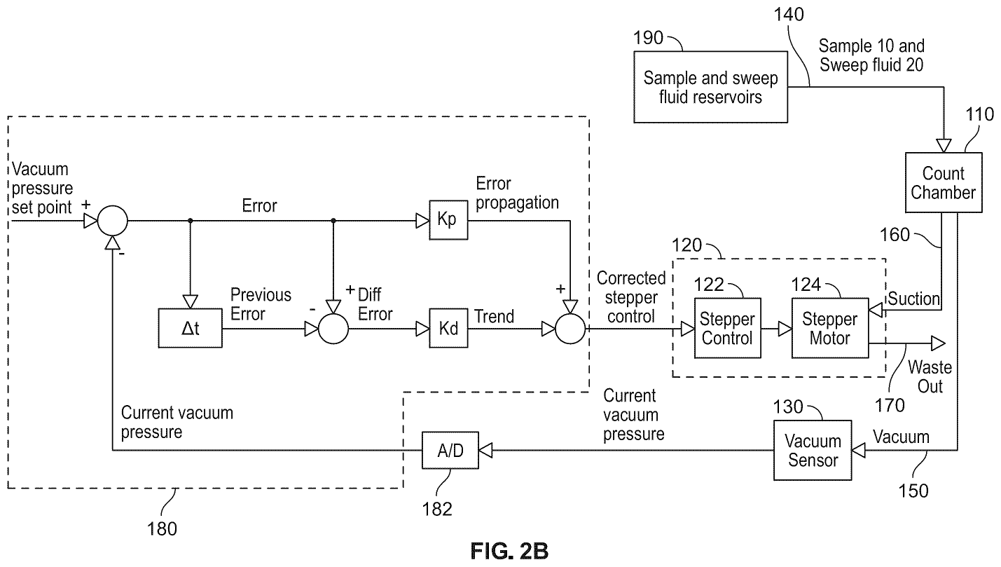

During operation, the pump 120 creates and maintains a vacuum in the count chamber 110. The pump 120 may be a peristaltic pump, a syringe pump, a helical pump or other type of pump. The pump 120 (as shown in FIGS. 2A and 2B) may include a stepper motor 124 and optionally a stepper motor controller 122. Such types of pumps 120 may be substantially quieter than a compressor used in legacy systems. In the case of the pump 120 being a peristaltic pump, such a pump 120 may further include a rotor rotatably coupled with the stepper motor. The rotor may include a shoe and a hose. The hose is at least partially arranged along a path in which the shoe travels when the rotor rotates. When the rotor rotates, the shoe compresses the hose along the length of the hose as the shoe travels in an arcuate direction. The rotor may rotate either clockwise or counterclockwise, thereby creating a vacuum at either end of the hose, depending on the direction of rotation. The stepper motor 124 controller 122 receives a signal (e.g., digital or analog signal), and responsively controls the stepper motor 124 (e.g., speed (e.g., step rate of the stepper motor 124 or revolutions per minute (RPM)) and/or direction of rotation) in a predetermined manner.

The stepper motor 124 causes the rotor to rotate and the correspondingly-rotating shoe to compress the hose along its length, such that fluid is pulled or pushed through the hose and a vacuum is created. The hose of the pump 120 is in fluid communication with the count chamber 110 via the drain aperture 116 and the drain line 160. By forcing fluid (e.g., gas or liquid) out of the count chamber 110, the pump 120 creates or adjusts a vacuum level in the count chamber 110. By forcing fluid into the count chamber 110, the pump 120 creates or adjusts positive pressure in the count chamber 110, and fluid in the count chamber 110 tends to be forced through the sample aperture(s) 112 and towards or into the input lines 140.

The input lines 140 may include valve(s) (not shown), such as one valve for each input line 140. The valves may selectively open or close the input lines 140, thereby controlling whether fluid flow is possible or not through input lines 140. The valve(s) may be controllable, for example, by the processor 180. There may be one input line 140 for each sample aperture 112.

The pneumatic sensor 130 is in fluid communication with the count chamber 110 via the sense line 150 and the sense line aperture 114 in the count chamber 110. The pneumatic sensor 130 generates an output signal (e.g., analog voltage signal) that corresponds in a predetermined manner to the level of vacuum that the pneumatic sensor 130 senses. The output signal from the pneumatic sensor 130 may be communicated to the processor 180 (an example of which is illustrated in FIGS. 2A and 2B).

FIG. 1B illustrates a portion of the particle counting system 100, according to embodiments. Particularly, FIG. 1B illustrates embodiments of features in the count chamber 110. A sample 10 including particles for assessment flows through an input line 140 to a sample aperture 112. There is a sweep fluid aperture 111 to receive the sweep fluid 20 from a sweep fluid reservoir (reservoir not shown). There may be a separate sweep fluid aperture 111 corresponding to each sample aperture 112. Inside the count chamber 110, in association with a given sample aperture 112, there is a sample flow region 113 and a sweep flow region 115 largely separated by at least one wall 117. The sample flows through the sample aperture 112, through a small distance of the sweep flow region 115, and into the sample flow region 113. At the same time, the sweep fluid 20 flows through the sweep flow region 115 and across or proximate the sample aperture 112. Some of the sweep fluid 20 passes through an aperture 119 between the sweep flow region 115 and the sample flow region 113. The flow of the sweep fluid 20 reduces the likelihood of particles in the sample 10 circulating back towards the sample aperture 112 once having flowed out of the sample aperture 112 and being counted more than once or otherwise creating an error in particle assessment by the system 100. The shape of a wall between the sweep flow region 115 and the sample flow region 113 may also prevent particles in the sample 10 from circulating out of the sample flow region 113 back towards the sample aperture 112.

The vacuum created by the pump 120 forces both the sample 10 through the sample flow region 113 and the sweep fluid 20 through the sweep flow region 115 and then to the drain line 160. Thus, the same vacuum level may drive the flow of both the sample 10 and the sweep fluid 20. The sweep fluid 20 may flow at a substantially larger rate than the rate of the sample 10 flow (e.g., one or more orders of magnitude larger). As the system 100 assesses the vacuum level in the count chamber 110, if there is a substantial deviation in the vacuum level (e.g., greater or less than a predetermined threshold), then the system 100 (e.g., processor 180, an example of which is shown in FIGS. 2A and 2B) may determine that there is an issue with the sweep fluid 20 flow (e.g., excessive bubbles in the flow of the sweep fluid 20).

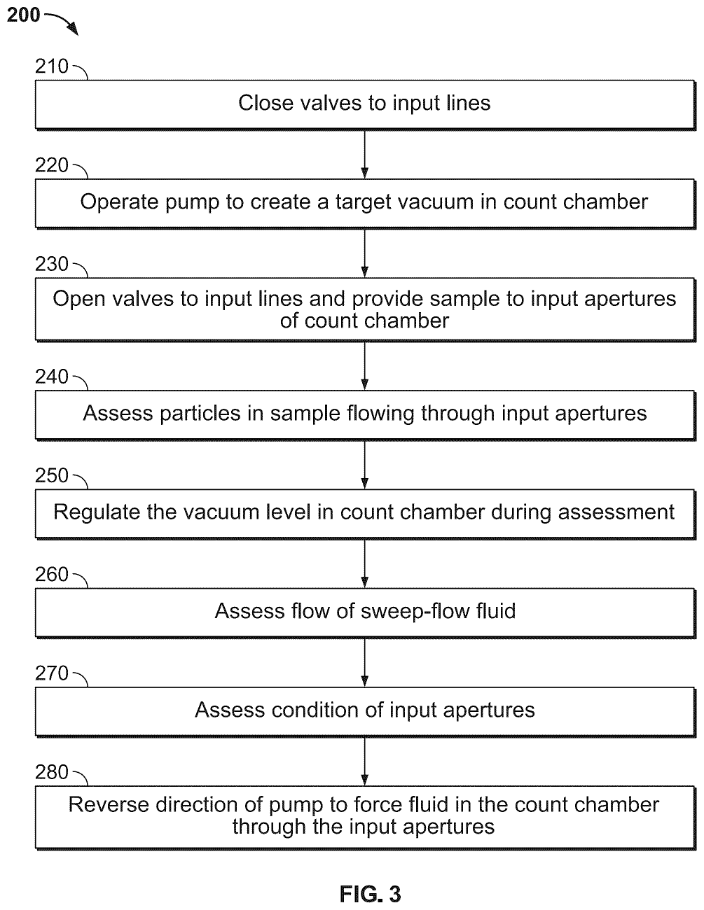

FIG. 2A shows a block diagram illustrating part of the system 100, according to embodiments. In addition to the components shown in FIG. 1A, the system 100 is further illustrated as including the processor 180 and reservoir(s) 190 for a sample 10 and/or sweep fluid 20. While FIGS. 2A and 2B show only one block for reservoir(s) 190, there can be separate reservoirs 190 which separately retain the sample 10 and the sweep fluid 20. Further, while FIGS. 2A and 3B show only one input line 140, there may be multiple input line(s) 140 for both the sample 10 and the sweep fluid 20. Also shown is an analog-to-digital converter 182, which may be part of the processor 180 or external to the processor 180. The processor 180 may receive a signal from the vacuum sensor 130 corresponding to the vacuum level in the count chamber 110. The output signal from the vacuum sensor 130 is shown as an analog signal, which is converted to a corresponding digital signal via the analog-to-digital converter 182, which is provided to the processor 180. The processor 180 controls the pump 120 based at least partially on the value(s) of the output signal from the vacuum sensor 130. The processor 180 further may control valve(s) on the input line(s) 140 to selectively allow or prevent fluid flow into the count chamber 110. The processor 180 may further control operations of the count chamber 110 in accordance with principles of a particle counter (e.g., hematology analyzer, such as a Coulter Counter), to measure a number of particles in the sample 10 and/or the size(s) of such particles. The processor 180 may be an integrated device, or may comprise multiple discrete devices, such as multiple processors. The processor 180 may be implemented in hardware and/or software. The processor 180 may include or be in communication with a memory that stores instructions. The processor 180 may retrieve and execute the instructions to cause operations described herein.

The processor 180 may be in communication with additional components, including a user interface (not shown) and a display (not shown). A user may be able to provide input to the processor 180 via the user input, and the processor 180 may control the display to present information (such as the types of information described herein) to the user.

The processor 180 may implement a negative feedback control scheme to control the pump 120 based on the output signal(s) from the vacuum sensor 130. The processor 180 may receive a value (e.g., from a user via the user input, or from a value stored in memory) specifying a vacuum level set-point. Exemplary set-points may be between approximately −3 Hg to approximately −6 Hg (e.g., −6 Hg). The processor 180 may compare the set-point with the current vacuum level in the count chamber 110 as sensed by the vacuum sensor 130. The processor 180 may determine a deviance of the current vacuum level in the count chamber 110 as compared to the set-point. For example, the processor 180 may perform a subtraction operation on the two values (e.g., the current vacuum level is subtracted from the set-point) to determine a differential or error. The error is provided to a block Kₚ that determines the proportional aspect of the error according to a proportional/derivative negative feedback control technique.

As part of the negative feedback proportional/derivative control scheme, the processor 180 may further determine a trend of change of the vacuum level in the count chamber 110 (e.g., a current value of the derivative of the time-varying vacuum levels). The processor 180 may store in memory previous levels of the vacuum level and compare those to the current vacuum level in the count chamber 110. For example, a previous vacuum level (e.g., the immediately previous vacuum level) in the count chamber 110 may be subtracted from the current vacuum level. This differential may be provided to a block K_{d} that determines a derivative aspect of a proportional/derivative negative feedback control technique. The block K_{d} may determine a trend in the rate of change of the vacuum level in the count chamber 110. This trend may be assessed with respect to the output from Kₚ (e.g., the trend may be subtracted from the output of Kₚ). This assessment may then be encoded as a control signal to control the pump 120. Specifically, the control signal is communicated to a stepper controller 122 (which may either be a part of or external to the pump 120), which in turn causes the stepper motor 124 to rotate in a specified direction and at a specified speed (e.g., measured in RPM). The adjustment of the pump 120 and/or continued operation of the pump 120 at a previous direction/speed may cause the vacuum level in the count chamber 110 to change, and the negative feedback control loop will further adjust or maintain the operation of the pump 120. The use of such a control technique may control the vacuum level in the count chamber 110 substantially in real time—e.g., vacuum level measurements being assessed or sampled at intervals between 5 μS and 100 mS, such as 10 μS. The use of such a control technique and associated pump 120 and vacuum sensor 130 may eliminate the need for a vacuum regulator. Furthermore, because vacuum level measurements can be assessed by the vacuum sensor 130 and processor 180 at a relatively rapid rate in system 100, the vacuum level information may be used to enhance the particle counting algorithm by better characterizing the rate of flow of the sample through the apertures 112.

FIG. 2B is similar to FIG. 2A, except that K_{d} determines a trend in the error or differential between the set point and the current vacuum level. The processor 180 may store in memory previous levels of the error and compare those to the current error or differential. For example, a previous error may be subtracted from the current error or differential. This differential resulting from the subtraction may be provided to a block K_{d} that determines a derivative aspect of a proportional/derivative negative feedback control technique. The block K_{d} may determine a trend in the rate of change of the error or differential.

The system 100 may be able to perform various diagnostics on the operation of the system 100, and in some cases, correct a diagnosed issue. For example, the system 100 may be able to determine whether one or more of the apertures 112 and/or sweep-flow aperture(s) 111 are blocked (either partially or completely). As another example, the system 100 may be able to determine whether the flow of sweep fluid 20 is primed, and is substantially free of air pockets.

When detecting an aperture 112 blockage, according to embodiments, to maintain the vacuum level in the count chamber 110 within specifications, as the sample 10 enters the count chamber 110, the pump 120 attempts to remove the same volume of air from the count chamber 110. The speed (e.g., RPM) of the pump 120 can be calibrated to accomplish this. If one or more of the apertures 112 are blocked, the feedback may set a speed of the pump 120 to a speed that is lower than expected. For example, if a count chamber 110 includes three apertures 112, when the system 100 is designed or calibrated, it is known that there must be a given speed X of the pump 120 to remove the same amount of volume of the sample 10 through the drain 116 as is entering through the apertures 112. However, the feedback algorithm may only be calling for the speed of the pump 120 to be (2/3)*X, which can indicate that one of the apertures 112 is blocked.

As another example, to assess the integrity of a given aperture 112, the system 100 may only open one aperture 112 at a time. The speed of the pump 120 may be set at a level determined during the calibration of the system 100, where that calibration was to have the rate of sample 10 flow through the drain 116 equal to the flow of the sample 10 through the aperture 112. If the measured vacuum is substantially maintained, then there may be no issue with the aperture 112. However, if the vacuum level is not adequately maintained, then there may be an issue with the integrity of the aperture 112 (e.g., a partial blockage). A similar type of diagnostic can be performed for the sweep-flow aperture 111 or subsystem.

To determine whether the flow of sweep fluid 20 is substantially or fully primed (or not), consider that gas has less resistance to flow. As such, the flow rate of an unprimed flow of sweep fluid 20 will have a higher volume rate than a primed sweep fluid 20 flow. As such, the feedback mechanism may drive the speed of the pump 120 to higher values than expected, and the controlling software may determine that the sweep fluid 20 flow is not primed.

The system 100 may further be capable of unblocking the apertures 112 or sweep-flow apertures 111 (hereinafter, the blocked aperture). Consider that, in the system 100, each sample aperture 112 or sweep-flow aperture 111 has a corresponding fluidic valve that enables/disables flow through the given aperture. In addition, the sweep-flow system also has a valve that can shut off the diluent input to the sweep-flow. Further, the system 100 has risk control measures that can detect if a given aperture is blocked (by measuring a DC voltage at the aperture). If the DC voltage is not what is expected, the system 100 may infer that the blocked aperture is partially or completely blocked. In the case that the DC voltage at a given aperture 112 or aperture 111 is not what is expected, the system 100 can attempt to dislodge the debris or material causing the blockage at the aperture 112 by: (a) closing the sweep-flow inlet valve (such that fluid flow through the sweep-flow inlet valve is not possible); (b) closing the valves 112 to the apertures 112 that are not in question; (c) opening the valve that corresponds to the blocked aperture 112; (d) operate the pump 120 in reverse, producing pressure inside the count chamber 110, which exposes the back side of the blocked aperture 112 to this pressure; and (c) subsequently measuring the DC voltage for the aperture 112. If the pressure in the count chamber 110 created by the reversed operation of the pump 120 is sufficient to unblock the aperture 112, then this can be detected by assessing the DC voltage at the aperture 112. If the DC voltage cannot be returned to an expected range after reversing the operation of the pump 110, then the system 100 may flag that there is an issue with the aperture 112 (which, for example, could trigger an alert for manual servicing of the system 100).

Similar to the reverse operation of the pump 120 technique to unblock blocked apertures, the system 100 can attempt to unblock an aperture 112 by cycling the operation of the pump 120 from normal operation (forward) to reverse operation, and optionally cycle through those two states, alternately, to create a push-pull on the blockage at the aperture 112.

Separately or in conjunction with the aforementioned unblockage schemes, the valve corresponding to the blocked aperture can be cycled open/closed to create a pressure wave to attempt to clear the blocked aperture.

FIG. 3 illustrates a flowchart 200 for a method of operation of a particle counting system, according to embodiments. The flowchart 200 is described with reference to particle counting system 100, but is not limited as such. All steps in the flowchart 200 are not mandatory. For example, without limitation, one or more of steps 270, 280, or 290 may be omitted. The steps in flowchart 200 may be performed in a different order. For example, without limitation, step 280 could be performed before step 240. Steps of the flowchart 200 may be performed simultaneously or during overlapping periods of time. For example, without limitation, performance of step 240 could overlap in time with performance of steps 230 and/or step 250. One or more steps of the flowchart 200 may be performed by the processor 180, or performed according to control by the processor 180. The processor 180 may perform the steps or provide control for the steps by executing instructions stored on a memory, thereby causing operations in the processor 180.

At step 210, the valves to the input lines 140 are closed, thereby preventing the sample 10 from flowing from the input lines 140, through the sample aperture(s) 112, and into the count chamber 110. Similarly, the sample 10 is prevented from flowing from the count chamber 110 and into the input lines 140. The valves may be closed under control of the processor 180. Valves to the lines to the sweep flow aperture(s) 111 may also be closed to prevent sweep fluid 20 from flowing into the count chamber 110.

At step 220, the pump 120 may be operated to create a target vacuum level (e.g., −6 Hg) in the count chamber 110. Such a vacuum level may be created according to the techniques described with respect to FIGS. 1A through 2B. During step 220, any sample 10 in the count chamber 110 may be substantially evacuated from the count chamber 110 to the waste out line 170. Similarly, a substantial amount of gas may be evacuated from the count chamber 110 by the pump 120.

At step 230, once the target vacuum level in the count chamber 110 has been obtained, the valves to input lines 140 may be opened (e.g., under control of the processor 180), and the sample 10 may be provided to the sample aperture(s) 112 of count chamber 110. The sample 10 may be a blood sample, and may include particles such as red blood cells, white blood cells, and platelets. The valve for the sweep fluid 20 may also be opened, thereby allowing the sweep fluid 20 to flow through the sweep flow aperture(s) 111.

At step 240, the particle counting system 100 may count the particles in the sample 10 and/or determine their sizes (e.g., a distribution of sizes for a given type of particle). Such count and size assessment may be performed according to principles known for Coulter counting methods.

At step 250, the vacuum level in the count chamber 110 may be maintained by the pump 120. The particle counting system 100 may control the pump 120 such that the volume of sample 10 and sweep fluid 20 exiting the count chamber 110 through the drain aperture 116 is approximately the same volume of sample 10 entering the count chamber 110 through the sample aperture(s) 112 and the volume of sweep fluid 20 through the sweep flow aperture(s) 111. The flow rate of the pump 120 may desirably match the flow rate entering the count chamber 110 through the sample aperture(s) 112 and the sweep flow aperture(s) 111. In such a way, the count chamber 110 may be substantially empty during particle assessment. Particle assessment may begin once the vacuum level in the count chamber 110 has been suitably stabilized to the set point vacuum level. Continuing through the process of particle assessment, the vacuum level in the count chamber 110 may be maintained in accordance with the techniques described in conjunction with FIGS. 1A, 1B, 2A, and 2B. While the vacuum level in the count chamber 110 is maintained, the particles in the sample 10 may continue to be assessed by the particle counting system 100, for example, in accordance with step 240. Assessment of the sample 10 may continue until the entire sample 10 (or a portion thereof) has been assessed.

When a peristaltic pump 120 is used, the particle counting system 100 may detect pump 120 tubing degradation. For example, a speed threshold for the stepper motor 124 of the pump may be predetermined in the system (e.g., the speed threshold is stored in memory associated with the processor 180). Such a speed threshold may be specified by a user through the user interface. Different speed thresholds may be used for different types or models of pumps 120. If the feedback control outputs a stepper motor 124 speed that is greater than the threshold, then this may indicate that the tubing in the pump 120 has degraded (e.g., there is a reduced flow through the tubing due to the tubing collapsing or the presence of accumulated material on the inner surface of the tubing). Such a technique of evaluating the controlled speed of the stepper motor 124 of the pump 120 to a threshold may indicate other issues with stepper motor 124 type pumps 120, such as stepper motor 124 degradation or stepper control 122 error.

At step 260, one or more conditions of the flow of the sweep fluid 20 may be assessed. During the flow of the sweep fluid 20, or more conditions of the sweep flow may be evaluated by the particle counting system 100. For example, the volume, velocity, or rate of the flow of the sweep fluid 20 may be assessed by the processor 180, as further explained above in context with FIG. 1B. If the volume, velocity, or rate of the flow of the sweep fluid 20 is not what is expected, then a condition of the flow of the sweep fluid 20 may be determined. For example, if the velocity of the flow of the sweep fluid 20 deviates from an expected rate, then it may be determined that there is an undesirable amount of gas in the flow of the sweep fluid 20. Under such a scenario, it may be determined by the processor 180 that the flow of the sweep fluid 20 has not been adequately primed. Corrective action may be taken to better prime the flow of the sweep fluid 20. Such corrective action may be performed automatically by the particle counting system 100, for example, under control of the processor 180. Alternatively, the user may be alerted about the inadequate priming via the display or through a speaker or through another method of communication (e.g., wireless communication to a remote device). Further, if there is an issue with the flow of the sweep fluid 20 detected by a deviation in the vacuum level in the count chamber 110, then the particle assessment results may be suppressed until the deviation in the flow of the sweep fluid 20 has abated or been resolved.

At step 270, condition(s) of the sample aperture(s) 112 may be assessed by the particle counting system 100, for example by the processor 180 or under the control of the processor 180. Such condition(s) may be assessed via evaluation of the voltage measured at the sample aperture(s) 112 according to Coulter counting techniques.

At step 280, the direction of the pump 120 (via direction of the stepper motor 124) may be reversed to force fluid (e.g., sample 10, sweep fluid 20, or gas) in the count chamber 110 through the sample aperture(s) 112. As part of this process, the valve(s) to the sweep flow aperture(s) 111 may be closed to better force fluid through the sample aperture(s) 112. By forcing fluid in a reversed direction in this manner, it may be possible to clear any blockage (complete blockage or partial blockage) in the sample aperture(s) 112. Such blockage at the sample aperture(s) 112 may be detected by determining whether a voltage (e.g., a voltage used to assess counting of particles) proximate a given sample aperture 112 is outside of an expected range. As another example, such blockage may be determined if the count through a given sample aperture 112 is substantially lower than count(s) at other aperture(s) 112 for the same particle type.

The examples provided herein are meant to be illustrative. For instance, red blood cells, white blood cells, and platelets are illustratively referred to, however, various types of other particles are contemplated, such as algae (e.g., for use in oceanography), pigment size (e.g., for use with paint), or any particle that is substantially an insulator.

Each of the calculations or operations described herein may be performed using a computer or other processor (e.g., processor 180) having hardware, software, and/or firmware. The various method steps may be performed by modules, and the modules may comprise any of a variety of digital and/or analog data processing hardware and/or software arranged to perform the method steps described herein. The modules optionally comprising data processing hardware adapted to perform one or more of these steps by having appropriate machine programming code associated therewith, the modules for two or more steps (or portions of two or more steps) being integrated into a single processor board or separated into different processor boards in any of a variety of integrated and/or distributed processing architectures. These methods and systems will often employ a tangible media embodying machine-readable code with instructions for performing the method steps described above. Suitable tangible media may comprise a memory (including a volatile memory and/or a non-volatile memory), a storage media (such as a magnetic recording on a floppy disk, a hard disk, a tape, or the like; on an optical memory such as a CD, a CD-R/W, a CD-ROM, a DVD, or the like; or any other digital or analog storage media), or the like.

All patents, patent publications, patent applications, journal articles, books, technical references, and the like discussed in the instant disclosure are incorporated herein by reference in their entirety for all purposes.

Different arrangements of the components depicted in the drawings or described above, as well as components and steps not shown or described are possible. Similarly, some features and sub-combinations are useful and may be employed without reference to other features and sub-combinations. Embodiments of the invention have been described for illustrative and not restrictive purposes, and alternative embodiments will become apparent to readers of this patent. In certain cases, method steps or operations may be performed or executed in differing order, or operations may be added, deleted or modified. It can be appreciated that, in certain aspects of the invention, a single component may be replaced by multiple components, and multiple components may be replaced by a single component, to provide an element or structure or to perform a given function or functions.

It will be understood by those skilled in the art that various changes may be made and equivalents may be substituted without departing from the scope of the novel techniques disclosed in this application. In addition, many modifications may be made to adapt a particular situation or material to the teachings of the novel techniques without departing from its scope. Therefore, it is intended that the novel techniques not be limited to the particular techniques disclosed, but that they will include all techniques falling within the scope of the appended claims.

1. A biological particle counting system comprising:
an impedance particle counter comprising at least one sample aperture;
a pump configured to pull particles through the at least one sample aperture of the impedance particle counter for counting, the pump producing a vacuum pressure; and
a stepper motor configured to adjust a speed of the pump to substantially maintain the vacuum pressure.

2. The biological particle counting system of claim 1, wherein the pump comprises a peristaltic pump.

3. The biological particle counting system of claim 1, wherein the impedance particle counter is configured to determine a count and size of the particles, and wherein the particles comprise red blood cells.

4. The biological particle counting system of claim 1, further comprising:
a sensor configured to monitor the vacuum pressure; and
a processor in communication with the sensor and the stepper motor, wherein the processor is configured to adjust the stepper motor to adjust the speed of the pump according to a signal from the sensor.

5. The biological particle counting system of claim 4, wherein the processor is further configured to adjust the stepper motor according to proportional-derivative negative feedback according to the signal from the sensor.

6. The biological particle counting system of claim 4, wherein the processor is further configured to detect a condition of the at least one sample aperture.

7. The biological particle counting system of claim 6, wherein the processor is further configured to push a fluid through the at least one sample aperture according to the condition of the at least one sample aperture.

8. The biological particle counting system of claim 1, wherein the pump is further configured to produce a sweep flow configured to move the particles away from the at least one sample aperture after counting, and further comprising a processor configured to detect a condition of the sweep flow.

9. The biological particle counting system of claim 8, wherein the processor is further configured to control the stepper motor to adjust the speed of the pump according to the condition of the sweep flow.

10. The biological particle counting system of claim 1, wherein the pump is further configured to push a fluid through the at least one sample aperture.

11. An impedance particle counter of a impedance particle analyzer comprising:
at least one sample aperture;
a pump configured to pull particles through the at least one sample aperture for counting, the pump producing a vacuum pressure; and
a stepper motor configured to adjust a pump speed to maintain the vacuum pressure.

12. The impedance particle counter of claim 11, wherein the pump comprises a peristaltic pump.

13. The impedance particle counter of claim 11, wherein the impedance particle counter is configured to determine a count and size of the particles, and wherein the particles comprise red blood cells.

14. The impedance particle counter of claim 11, further comprising:
a sensor configured to monitor the vacuum pressure; and
a processor in communication with the sensor and the stepper motor, wherein the processor is configured to adjust the stepper motor to adjust the pump speed according to a signal from the sensor.

15. The impedance particle counter of claim 14, wherein the processor is further configured to adjust the stepper motor according to proportional-derivative negative feedback according to the signal from the sensor.

16. The impedance particle counter of claim 14, wherein the processor is further configured to detect a condition of the at least one sample aperture.

17. The impedance particle counter of claim 16, wherein the processor is further configured to push a fluid through the at least one sample aperture according to the condition of the at least one sample aperture.

18. The impedance particle counter of claim 11, wherein the pump is further configured to produce a sweep flow configured to move the particles away from the at least one sample aperture after counting, and further comprising a processor configured to detect a condition of the sweep flow.

19. The impedance particle counter of claim 18, wherein the processor is further configured to control the stepper motor to adjust the pump speed according to the condition of the sweep flow.

20. The impedance particle counter of claim 11, wherein the pump is further configured to push a fluid through the at least one sample aperture.
